(19) United States
(12) Patent Application Publication
(10) Pub. No.: US 2026/0244594 A1
(43) Pub. Date: Aug. 20, 2026

(54) INTER-CORE COMMUNICATION SYSTEM AND CHIP CIRCUIT

(71) Applicant: Black Sesame Technologies Co., Ltd., Wuhan (CN)

(72) Inventor: Shengnan Li, Shenzhen (CN)

(21) Appl. No.: 19/459,978

(22) Filed: Jan. 26, 2026

(30) Foreign Application Priority Data
Feb. 17, 2025 (CN) 2025101742882

(51) Int. Cl. G06F 15/80

(52) U.S. Cl. CPC G06F 15/80

(57) ABSTRACT

An inter-core communication system, comprising: multiple processor cores in a secure state or a non-secure state and a plurality of buffer processing units in one-to-one correspondence to the multiple processor cores. Each producer core generates a transfer message and writes the transfer message into the buffer processing unit corresponding thereto. The consumer core reads the transfer message from the buffer processing unit corresponding thereto. The transfer message includes a secure transfer message and a non-secure transfer message. The receive buffer of the buffer processing unit is divided into a secure buffer area and a non-secure buffer area. The secure transfer message is routed to the secure buffer area. The non-secure transfer message is routed to the non-secure buffer area. The secure transfer message in the secure buffer area can be read only by the consumer core in the secure state.

### RELATED APPLICATION

This application claims the benefit under 35 U.S.C. § 119(a) of the filing date of Chinese Patent Application No. 2025101742882, filed in the Chinese Patent Office on Feb. 17, 2025. The disclosure of the foregoing application is herein incorporated by reference in its entirety.

### TECHNICAL FIELD

The present disclosure relates to the field of system-on-chip (SoC) technologies, and in particular, to an inter-core communication system and a chip circuit.

### BACKGROUND

In an inter-core communication system, transfer messages are transmitted between various processor cores, and security of transmission of the transfer messages between different processor cores becomes critically important. Software applications with different security levels run on the processor cores. Existing inter-core communication systems fail to fully consider security levels of both the transfer messages and the software applications, which may allow non-secure software applications to obtain excessive access permissions and then access transfer messages with higher security levels. For example, sensitive information is accidentally accessed and improperly processed in a non-secure environment, thereby creating a risk of data leakage and affecting overall security of the system.

### SUMMARY

In one aspect of the present disclosure, an inter-core communication system is provided, including a plurality of processor cores in a secure state or a non-secure state and a plurality of buffer processing units in one-to-one correspondence to the plurality of processor cores; wherein each of the processor cores is a producer core or a consumer core, the producer core being configured to generate a transfer message and write the transfer message into the buffer processing unit corresponding thereto, the consumer core being configured to read the transfer message from the buffer processing unit corresponding thereto, the transfer message including a secure transfer message and a non-secure transfer message; and each of the buffer processing units includes a receive buffer, the receive buffer being divided into a secure buffer area and a non-secure buffer area, the secure transfer message being routed from the buffer processing unit corresponding to the producer core to the secure buffer area of the buffer processing unit corresponding to the consumer core, the non-secure transfer message being routed from the buffer processing unit corresponding to the producer core to the non-secure buffer area of the buffer processing unit corresponding to the consumer core, and the secure transfer message in the secure buffer area being read only by the consumer core in the secure state.

In some embodiments, the transfer message includes a security flag bit indicating whether the transfer message is a secure transfer message or a non-secure transfer message; the producer core is further configured to generate a secure state signal based on a hardware state thereof, and write the secure state signal along with the transfer message into the buffer processing unit corresponding thereto, the secure state signal indicating whether the producer core is in a secure state or a non-secure state when writing the transfer message into the buffer processing unit corresponding thereto; and the buffer processing unit includes a security correction circuit, the security correction circuit being configured to correct, based on the secure state signal and the security flag bit in the transfer message, the security flag bit in the transfer message.

In some embodiments, the security correction circuit is configured to invert the security flag bit when the secure state signal indicates that the producer core is in the non-secure state and the security flag bit in the transfer message indicates that the transfer message is a secure transfer message, to cause the transfer message to be changed into a non-secure transfer message.

In some embodiments, the security correction circuit includes a first inverter, a second inverter, a third inverter, and an AND gate circuit, an input terminal of the first inverter serving as a first input terminal of the security correction circuit, an input terminal of the second inverter serving as a second input terminal of the security correction circuit, an output terminal of the first inverter and an output terminal of the second inverter being respectively connected to two input terminals of the AND gate circuit, an output terminal of the AND gate circuit being connected to an input terminal of the third inverter, and an output terminal of the third inverter serving as an output terminal of the security correction circuit; and the secure state signal is inputted to the first input terminal of the security correction circuit, the security flag bit is inputted to the second input terminal of the security correction circuit, and a signal outputted from the output terminal of the security correction circuit serves as a corrected security flag bit.

In some embodiments, the buffer processing unit further includes a configuration register, a value of the configuration register being set only by the processor core in the secure state; and the processor core in the secure state divides, by setting the value of the configuration register in the buffer processing unit corresponding to the processor core, the receive buffer into the secure buffer area and the non-secure buffer area, and sets address ranges of the secure buffer area and the non-secure buffer area.

In some embodiments, the buffer processing unit further includes: one or more message filters, the message filters corresponding to different buffer address segments in the receive buffer; the one or more message filters being each configured to receive the transfer message routed from the buffer processing unit corresponding to the producer core, filter the received transfer message based on a respective filtering rule, and write a filtered transfer message to the corresponding buffer address segment.

In some embodiments, each of the message filters includes a parameter configuration register, and the processor core configures, by setting a value of the parameter configuration register in the message filter in the buffer processing unit corresponding to the processor core, the filtering rule of the message filter and a range of the buffer address segment corresponding to the message filter.

In some embodiments, the parameter configuration register includes a security flag register, a value of the security flag register being set only by the processor core in the secure state; the processor core in the secure state configures, by setting the value of the security flag register in the message filter, the message filter as a secure message filter or a non-secure message filter, the secure message filter being configured to filter the secure transfer message, and the non-secure message filter being configured to filter the non-secure transfer message; and the range of the buffer address segment corresponding to the secure message filter is located within the address range of the secure buffer area, and the range of the buffer address segment corresponding to the non-secure message filter is located within the address range of the non-secure buffer area.

In some embodiments, the value of the parameter configuration register in the message filter of the secure message filter is set only by the processor core in the secure state.

In another aspect of the present disclosure, a chip circuit is provided, including the inter-core communication system according to the embodiments of the present disclosure.

According to the inter-core communication system and the chip circuit in the present disclosure, the buffer processing units serve as ends for transmission and routing of transfer messages, and are distributed in one-to-one correspondence to the processor cores, which prevents sharing of a shared memory by a plurality of processor cores for inter-core communication and improves read/write efficiency of the transfer messages, thereby enhancing inter-core communication efficiency of the transfer messages. On this basis, secure transfer messages with higher security levels are routed to the secure buffer areas of the buffer processing units corresponding to the consumer cores. The secure buffer areas only permit access by the consumer cores in the secure state. In this way, the processor cores in the non-secure state cannot read the secure transfer messages. Therefore, operations and data transfers in the non-secure state are strictly separated, to prevent interference with or damage to secure core functions of the system by activities in non-secure areas. The inter-core communication system in the present disclosure prevents leakage of and unauthorized access to the secure transfer messages, greatly reduces the risk of leakage of sensitive information, and effectively prevents data leakage caused by unauthorized operations. In addition, since the secure buffer area only serves the consumer cores in the secure state, resource contention is reduced. The inter-core communication system in the present disclosure can effectively protect transfer messages with different security levels, thereby meeting growing requirements for system security.

### BRIEF DESCRIPTION OF THE DRAWINGS

FIG. 1 is a schematic diagram of an inter-core communication system according to embodiments of the present disclosure;

FIG. 2 is a further schematic diagram of the inter-core communication system according to embodiments of the present disclosure;

FIG. 3 is a schematic diagram of configuration of a message buffer module according to embodiments of the present disclosure;

FIG. 4 is a schematic structural diagram of a security correction circuit according to embodiments of the present disclosure;

FIG. 5 is a schematic diagram of configuration of a buffer processing unit according to embodiments of the present disclosure; and

FIG. 6 is a schematic diagram of an example of a corresponding relationship between message filters and buffer address segments in a receive buffer according to embodiments of the present disclosure.

### DETAILED DESCRIPTION

In existing SoCs, a shared memory technology is typically employed to enable communication between a plurality of processor cores distributed across a plurality of subsystems. A shared memory refers to a memory region that can be directly accessed by cores of a plurality of processors (e.g., CPUs). In a multi-core system, processes or threads running on different processor cores often require frequent data exchange. A plurality of processor cores share the same system bus to access a shared memory, thereby transmitting data through the shared memory. Inter-core communication is performed through the shared memory, and data entering and exiting the shared memory also require complex processes such as memory controller scheduling and row/column address decoding, which increases read/write latency, complicates an operation flow, leads to a large delay, and results in lower efficiency. In addition, in an existing inter-core communication mechanism, there is a lack of security classification for transfer messages, making it difficult to distinguish transfer messages with different security levels during communication, thereby causing a risk of leakage of sensitive data.

The present disclosure provides an inter-core communication system based on a distributed architecture, which can improve inter-core communication efficiency and also improve communication security.

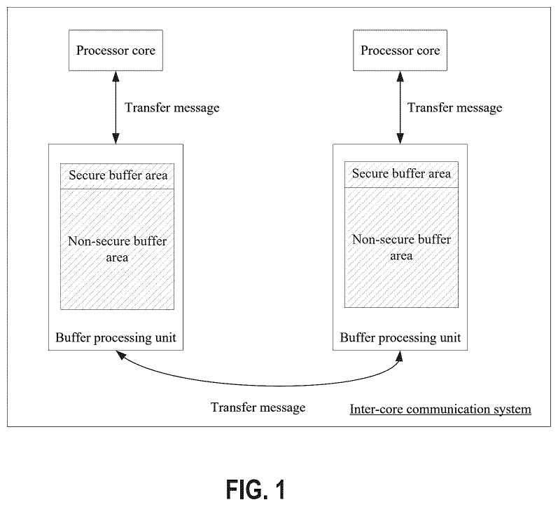

FIG. 1 is a schematic diagram of an inter-core communication system according to embodiments of the present disclosure. The inter-core communication system is configured for communication between a plurality of processor cores, for example, message transfer between the plurality of processor cores. The communication between the plurality of processor cores may be communication between a plurality of processor cores in thesame processor or communication between processor cores in different processors. The communication between the plurality of processor cores may be communication between a plurality of processor cores in the same subsystem in the inter-core communication system or communication between a plurality of processor cores in different subsystems in the inter-core communication system. The inter-core communication system according to the present disclosure may be applied to an SoC, and the plurality of processor cores may be located on the same SoC. In the present disclosure, transmission of a transfer message between the plurality of processor cores is performed via a hardware link.

As shown in FIG. 1, the inter-core communication system includes a plurality of processor cores in a secure state or a non-secure state and a plurality of buffer processing units in one-to-one correspondence to the plurality of processor cores.

Each processor core is a producer core or a consumer core. The producer core is configured to generate a transfer message and write the transfer message into the buffer processing unit corresponding thereto. The consumer core is configured to read the transfer message from the buffer processing unit corresponding thereto.

The producer core is a processor core responsible for generating data or resources, and the consumer core is a processor core responsible for using or processing such data or resources. In the inter-core communication system according to the present disclosure, the producer core generates and sends a transfer message, and the consumer core receives and uses the transfer message. It is easy to understand that both the producer core and the consumer core are processor cores in the inter-core communication system, which are merely role divisions during inter-core communication. A processor core in the inter-core communication system serves as a producer core when generating and sending a transfer message, and serves as a consumer core when receiving and using the transfer message. A recipient of the transfer message may be one or more consumer cores. For example, a transfer message generated by one producer core may be transmitted to one or more consumer cores.

The buffer processing unit is connected to the processor core corresponding thereto via a hardware link, for example, via a bus. The processor core and the buffer processing unit corresponding thereto are located in the same subsystem of the inter-core communication system, and the buffer processing unit is disposed near the processor core corresponding thereto. The producer core and the consumer core may be located in the same subsystem or different subsystems in the inter-core communication system. The buffer processing unit, serving as a transmission end of the transfer message, is a logic circuit that can perform processing such as filtering and buffering on the transfer message.

In the inter-core communication system shown in FIG. 1, each processor core can run software applications thereon to perform predetermined operations and implement predetermined functions. The processor core serving as a producer core generates a transfer message. For example, the transfer message is generated through a software application running on the producer core. The producer core transmits, via a bus connected thereto, the generated transfer message to the buffer processing unit corresponding thereto, the transfer message is then routed from the buffer processing unit corresponding to the producer core via a message routing unit to the buffer processing unit corresponding to the processor core serving as a consumer core, and the consumer core reads, via a bus corresponding thereto, the transfer message from the buffer processing unit corresponding thereto, thereby achieving transfer of the transfer message from the producer core to the consumer core and realizing inter-core communication.

The processor core in the inter-core communication system may be in a secure state or a non-secure state. Whether the processor core is in the secure state or the non-secure state is determined by whether the software application running thereon has a security requirement. The processor core being in the secure state means that the software application running thereon has a security requirement. The processor core being in the non-secure state means that the software application running thereon does not have any security requirement. In other words, when the software application running on the processor core has a security requirement, for example, when the security level of the software application running on the processor core is higher than a predetermined level, the processor is in the secure state, for example, operates in a secure mode. When the software application running on the processor core does not have any security requirement, for example, if the security level of the software application running on the processor core is lower than the predetermined level, the processor is in the non-secure state, for example, operates in a non-secure mode. When the running software application involves sensitive information or information related to system security, it may be considered that the software application has a security requirement. When the running software application involves only general, public data and does not involve sensitive information or information related to system security, it may be considered that the software application does not have any security requirement.

The transfer message includes a secure transfer message and a non-secure transfer message. The secure transfer message refers to messages related to system security. Once the messages are leaked, tampered with, or corrupted, secure operation of the system may be affected. The secure transfer message refers to transfer messages whose security levels are higher than the predetermined level. The non-secure transfer message refers to transfer messages unrelated to system security. The non-secure transfer message refers to transfer messages whose security levels are lower than the predetermined level. Even if a non-secure message is illegally acquired, it may not pose a serious security risk to the system.

Each buffer processing unit includes a receive buffer. The receive buffer is divided into a secure buffer area and a non-secure buffer area. The secure transfer message is routed from the buffer processing unit corresponding to the producer core to the secure buffer area of the buffer processing unit corresponding to the consumer core. The non-secure transfer message is routed from the buffer processing unit corresponding to the producer core to the non-secure buffer area of the buffer processing unit corresponding to the consumer core. The secure transfer message in the secure buffer area can be read only by the consumer core in the secure state.

For example, each buffer processing unit may include a send buffer (not shown) and a receive buffer, for example, one send buffer and one receive buffer, which are configured respectively to buffer transfer messages to be sent and to be received by the processor core corresponding to the buffer processing unit. Specifically, the send buffer may be configured to buffer transfer messages sent by the processor core corresponding to the buffer processing unit where the send buffer is located, and the receive buffer may be configured to buffer transfer messages to be received by the processor core corresponding to the buffer processing unit where the receive buffer is located. For example, the send buffer and the receive buffer may be first input first output (FIFO) buffers.

Referring to FIG. 1, the receive buffer is indicated by a shaded area. A transfer message generated by the producer core is transmitted, via a bus connected thereto, to the buffer processing unit corresponding thereto, and is buffered in the send buffer in the buffer processing unit. The send buffer then forwards the transfer message via a hardware link to a routing unit, which is routed by the routing unit via the hardware link to the buffer processing unit corresponding to the consumer core and is buffered in the receive buffer in the buffer processing unit corresponding to the consumer core. The consumer core accesses the receive buffer via a bus connected thereto and reads, from the receive buffer, the transfer message buffered therein. The routing unit may be understood as a logic circuit configured to implement functions such as forwarding and routing of the transfer message.

The receive buffer divides an address range of a memory space thereof into two parts. One part serves as the secure buffer area, and the other part serves as the non-secure buffer area. The secure transfer message is routed to the secure buffer area. The non-secure transfer message is routed to the non-secure buffer area. Therefore, a specific address range is set in the receive buffer to buffer the secure transfer message. In the illustrated example, the secure buffer area is located in a high address segment in the receive buffer, and the non-secure buffer area is located in a low address segment in the receive buffer. For example, in the illustrated example, addresses of the receive buffer are arranged from top to bottom in descending order.

The secure buffer area in the receive buffer can be accessed only by the processor core in the secure state, so that the secure transfer message routed to the secure buffer area in the receive buffer of the buffer processing unit corresponding to the consumer core can be read only by the consumer core in the secure state.

According to the inter-core communication system in the present disclosure, the buffer processing units serve as ends for transmission and routing of transfer messages, and are distributed in one-to-one correspondence to the processor cores, which prevents sharing of a shared memory by a plurality of processor cores for inter-core communication and improves read/write efficiency of the transfer messages, thereby enhancing inter-core communication efficiency of the transfer messages. On this basis, secure transfer messages with higher security levels are routed to the secure buffer areas of the buffer processing units corresponding to the consumer cores. The secure buffer areas only permit access by the consumer cores in the secure state. In this way, the processor cores in the non-secure state cannot read the secure transfer messages. Therefore, operations and data transfers in the non-secure state are strictly separated, to prevent interference with or damage to secure core functions of the system by activities in non-secure areas. The inter-core communication system in the present disclosure prevents leakage of and unauthorized access to the secure transfer messages, greatly reduces the risk of leakage of sensitive information, and effectively prevents data leakage caused by unauthorized operations. In addition, since the secure buffer area only serves the consumer cores in the secure state, resource contention is reduced. The inter-core communication system in the present disclosure can effectively protect transfer messages with different security levels, thereby meeting growing requirements for system security.

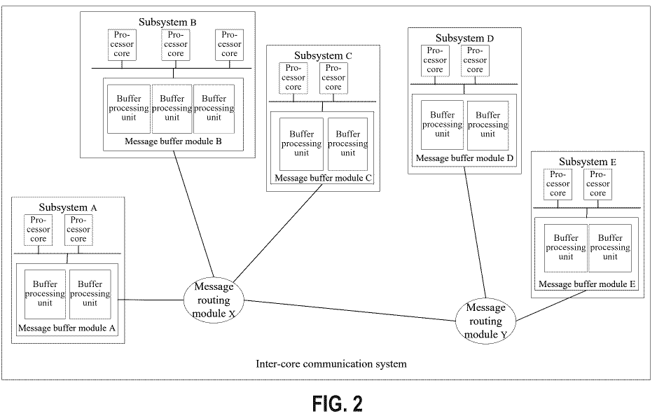

FIG. 2 is a further schematic diagram of the inter-core communication system according to embodiments of the present disclosure. The inter-core communication system includes a plurality of subsystems, for example, subsystems A to E. Each subsystem includes one or more processor cores. A number of the processor cores in each subsystem is not specifically limited. Each subsystem includes at least one message buffer module corresponding to the subsystem. For example, message buffer modules A to E shown in FIG. 2 are in one-to-one correspondence to the subsystems A to E. Each subsystem integrates a message buffer module as a transmission node for the transfer message. The message buffer module is integrated in the subsystem corresponding thereto and serves as part of the subsystem corresponding thereto. The message buffer module may be understood as a logic circuit configured to implement functions such as decoding, buffering, and forwarding of the transfer message. For example, each subsystem includes one message buffer module. It is easy to understand that only one subsystem may be provided in the inter-core communication system of the present disclosure. The subsystems A to E are subsystems in an SoC, which are partitioned according to implemented functions. For example, circuits and components in a chip are categorized into one or more subsystems according to functions and effects, and each subsystem has independent functional logic. For example, the subsystems may be a security subsystem, a protection subsystem, a media subsystem, a peripheral control subsystem, and the like in the SoC respectively.

The processor core in each subsystem is connected, via a bus, to the message buffer module corresponding to the subsystem where the processor core is located. Each message buffer module corresponds to all processor cores in the subsystem where the message buffer module is located. All the processor cores in each subsystem are connected to the corresponding message buffer module (i.e., the message buffer module integrated in the subsystem where the processor cores are located) via a bus. Each subsystem has an independent bus. Therefore, the bus connected to the producer core and the bus connected to the consumer core may be the same bus or different buses. When in the same subsystem, the producer core and the consumer core are connected to the same bus. When in the same subsystem, the producer core and the consumer core are connected to different buses. The bus in each subsystem is required only to connect the processor cores in the subsystem, rather than connecting all the processor cores in all the subsystems of the inter-core communication system to the same bus, which thus reduces a load of data transmission on the bus in each subsystem, prevents bus congestion to some extent, and reduces a physical distance of data links used to transmit transfer messages, thereby reducing a waiting time for the processor to send data.

In some examples, the subsystem may include a processor circuit block and a peripheral circuit block. The peripheral circuit block includes circuit components configured to implement the functions of the subsystem. The peripheral circuit blocks of the subsystems may be different. The processor circuit block integrates a series of key components and circuits that are closely related to the processor. One or more processors are integrated in the processor circuit block. Each processor may be a single-core processor or a multi-core processor. For example, each processor includes one or more processor cores. In the present disclosure, the message buffer module is integrated in the processor circuit block. In the processor circuit block, all processor cores in the processor circuit block are connected to the message buffer module via a bus, and the transfer message may be transmitted between the message buffer module and the processor core via the bus. The transfer message is transmitted in the SoC via a hardware link. The message buffer module is integrated in the processor circuit block of each subsystem, and transmission links for the transfer of messages from the processor core to the message buffer module and from the message buffer module back to the processor core are relatively short, enabling the processor core in the subsystem to access the message buffer module more quickly. In the present disclosure, the bus is, for example, an advanced high performance bus (AHB).

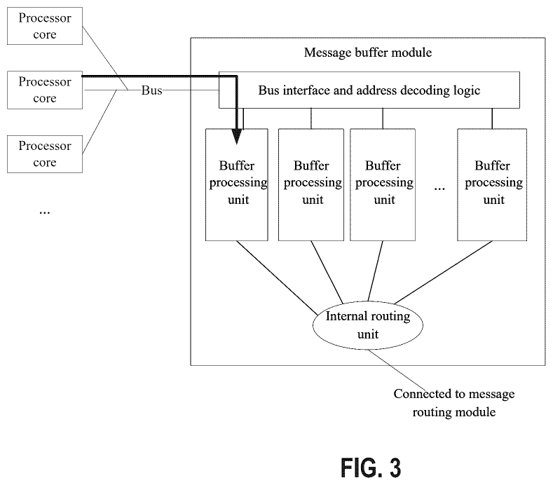

FIG. 3 is a schematic diagram of configuration of a message buffer module according to embodiments of the present disclosure. As shown in FIG. 3, each message buffer module may include one or more buffer processing units. FIG. 3 further illustrates a plurality of processor cores connected to the message buffer module via a bus. The processor cores are located in the same subsystem as the message buffer module, and correspond to the message buffer module. As described above, the one or more buffer processing units are in one-to-one correspondence to the one or more processor cores in the subsystem where the message buffer module is located. For example, when a subsystem A includes 2 processor cores, a message buffer module A includes at least 2 buffer processing units, and the 2 buffer processing units are in one-to-one correspondence to the 2 processor cores in the subsystem A. It is easy to understand that if the message buffer module A includes more than 2 buffer processing units, some of the buffer processing units may be not be enabled. The buffer processing unit is a sub-logic circuit in the message buffer module, which may be understood as an end in a transmission node. A plurality of buffer processing units in each message buffer module may transmit the transfer message with each other.

Each message buffer module may further include an internal routing unit configured to route the transfer message in the subsystem. For example, one message buffer module includes one internal routing unit. The internal routing unit is configured to route the transfer message, and route the transfer message to a corresponding destination. The internal routing unit corresponds to all the buffer processing units in the buffer processing module where the internal routing unit is located. The internal routing unit is connected to all the buffer processing units in the buffer processing module where the internal routing unit is located. The “connection” above refers to a connection via a hardware link. The transfer messages may communicate, via a bus, between the buffer processing unit and the internal routing unit corresponding thereto.

The inter-core communication system may further include one or more message routing modules. The message routing modules may be modules outside the subsystems A to E in an SoC system, which may be understood as logic circuits configured to implement functions such as forwarding and routing of the transfer message.

The one or more message routing modules are each connected to the message buffer module in at least one subsystem corresponding thereto, more specifically, to the internal routing unit in the message buffer module in at least one subsystem corresponding thereto. Each message routing module corresponds to at least one subsystem in the inter-core communication system. Therefore, each message routing module corresponds to at least one message buffer module in the inter-core communication system, and each message routing module is connected to the at least one message buffer module corresponding thereto. It is understood that each subsystem and each message buffer module have a corresponding message routing module, and correspond to only one message routing module. When the inter-core communication system includes a plurality of message routing modules, the message routing modules are interconnected, and the transfer message can be transmitted between the plurality of message routing modules.

For example, as shown in FIG. 2, message routing modules X and Y are interconnected, the message routing module X is connected to message buffer modules A, B, and C, and the message routing module Y is connected to message buffer modules D and E. The “connection” above refers to a connection via a hardware link. Transfer messages may communicate, via hardware links, between the message buffer modules and the message routing modules corresponding thereto and between the plurality of message routing modules.

It should be understood that the inter-core communication system may include only one message routing module. In this case, the message buffer modules in all the subsystems are connected to this message routing module. The message routing module is configured to route the transfer message between the buffer processing units, thereby enabling the buffer processing units located in different subsystems of the inter-core communication system to transmit the transfer message to each other.

In the example shown in FIG. 2, a transfer message is generated by the producer core, the producer core writes, via a bus, the transfer message to the message buffer module in the subsystem where the producer core is located, and the message buffer module receives the transfer message via a bus interface thereof. The message buffer module processes the received transfer message via address decoding logic to identify the producer core from which the transfer message originates, and then writes the transfer message into the send buffer in the buffer processing unit corresponding to the producer core. The send buffer in the buffer processing unit corresponding to the producer core transmits the transfer message via the internal routing unit to the receive buffer in the buffer processing unit corresponding to the consumer core, and the consumer core reads the transfer message from the receive buffer in the buffer processing unit corresponding thereto, thereby realizing transfer of the transfer message from the producer core to the consumer core and achieving inter-core communication. It is easy to understand that if the producer core and the consumer core are not located in a same subsystem, after the transfer message is transmitted to the internal routing unit in the message buffer module corresponding to the producer core, the transfer message is routed by the internal routing unit to the message routing module connected thereto, routed by the message routing module to the internal routing unit in the message buffer module corresponding to the consumer core, and then routed by the internal routing unit in the message buffer module corresponding to the consumer core to the buffer processing unit corresponding to the consumer core.

In the example shown in FIG. 2, each subsystem includes a message buffer module as a transmission node for the transfer message, and the message buffer module includes buffer processing units in one-to-one correspondence to the processor cores as transmission ends for the transfer message. The transmission nodes and the transmission ends are integrated in the subsystems in a distributed manner, which can improve read/write efficiency of the transfer message, thereby improving inter-core communication efficiency of the transfer message. In addition, a smaller number of processor cores are connected to the same bus, which reduces a load of data transmission on the bus and prevents bus congestion to some extent. In this way, the processor cores exhibit lower latency during inter-core communication, thereby reducing a load on the processors in each subsystem. Moreover, the inter-core communication system employs a distributed architecture, having excellent scalability.

In some embodiments, the transfer message may include a security flag bit indicating whether the transfer message is a secure transfer message or a non-secure transfer message. The producer core may further be configured to generate a secure state signal based on a hardware state thereof, and write the secure state signal along with the transfer message into the buffer processing unit corresponding thereto. The secure state signal indicates whether the producer core is in a secure state or a non-secure state when writing the transfer message into the buffer processing unit corresponding thereto. The buffer processing unit may include a security correction circuit. The security correction circuit is configured to correct, based on the secure state signal and the security flag bit in the transfer message, the security flag bit in the transfer message.

For example, the transfer message may include a message header and a payload. The message header generally carries key metadata, such as a source, a destination, and a type of the transfer message. When a transfer message is sent or received, the message header is sent or received first, enabling a receiving end to know in advance how to process subsequent data. The payload refers to a main content body of the transfer message. The security flag bit indicates security of the transfer message. The security flag bit may be a bit in the message header, which may be “1” or “0”. For example, when the security flag bit is “1,” it indicates that the transfer message is a non-secure transfer message. When the security flag bit is “0,” it indicates that the transfer message is a secure transfer message.

The message header of the transfer message, as part of the transfer message, is generated by a software application running on the producer core. Therefore, the security flag bit of the transfer message is set by the software application running on the producer core. Typically, when the software application running on the producer core has a security requirement, the generated transfer messages may be a secure transfer message or a non-secure transfer message. When the software application running on the producer core does not have any security requirement, the generated transfer message is a non-secure transfer message. However, in an attempt to gain more permissions, some software applications without security requirements may maliciously generate a transfer message as a secure transfer message. For example, the software applications without security requirements might tamper with the security flag bit of the generated transfer message to “0”. This may affect system performance and communication security.

In some examples, the message header of the transfer message may further include a producer core identifier field used to identify the producer core from which the transfer message originates, and a consumer core identifier field used to identify the consumer core to which the transfer message is to be sent. The producer core identifier field and the consumer core identifier field are used to determine a routing path and a destination of the transfer message during routing in inter-core communication. The message header of the transfer message may further include length information, width information, a flag bit indicating whether to be a loopback test message, reserved fields definable by the software application, and the like of the transfer message.

The producer core generates a secure state signal based on a hardware state thereof. The generation of the secure state signal is performed substantially concurrently with the generation of the transfer message. For example, in some of the above examples, the transfer message generated by the producer core is written into the corresponding buffer processing unit via the bus connected to the producer core. In this case, in order to use the bus to write the transfer message, the producer core is required to initiate a bus request to the bus. The bus request is a signal issued by a processor (e.g., a processor core) to the system bus, intended to request control over the bus for data transmission, access to a memory or another device, and the like. In this case, the bus request carries the secure state signal corresponding to the transfer message.

The secure state signal indicates whether the producer core is in a secure state or a non-secure state when writing the transfer message into the buffer processing unit corresponding thereto. The same transfer message is necessarily generated by the same software application, for example, the software application running on the producer core remains unchanged when the same transfer message is generated and written, and whether the software application has a security requirement may not change. Therefore, when the same transfer message is written into the buffer processing unit corresponding thereto, the secure state of the producer core may not change, and the secure state signal thereof may not change, either. For example, it may be understood that one transfer message corresponds to one secure state signal.

The secure state signal may be represented by “1” or “0”, indicating that the producer core is in a non-secure state and in a secure state, respectively. As can be seen from the above, when the software application running on the processor core has a security requirement, for example, when the security level of the software application running on the processor core is higher than a predetermined level, the processor is in the secure state, for example, operates in a secure mode. When the software application running on the processor core does not have any security requirement, for example, the security level of the software application running on the processor core is lower than the predetermined level, the processor is in the non-secure state, for example, operates in a non-secure mode. When the processor core runs in the secure mode, hardware of the processor core may enable a series of additional security mechanisms. When the processor operates in the non-secure mode, the hardware of the processor core may optimize resource allocation, which prevents unnecessary security overhead, thereby enhancing operational efficiency. For example, the processor core has different hardware states when in the secure state and in the non-secure state. The processor core, based on the hardware state thereof, can accurately determine whether the processor core is currently in the secure state or the non-secure state. Since the hardware state is difficult to tamper with, the secure state signal generated based on the hardware state has high reliability.

Further, the secure state signal is set by a hardware circuit of the processor core (or the processor where the processor core is located). For example, the hardware circuit sets the secure state signal to “1” or “0”. Based on the reliability of the hardware circuit, the secure state signal is difficult to tamper with.

Furthermore, the secure state signal may be a control signal in a bus protocol of the bus connected to the producer core, such as an Hnonsec control signal in an AHB protocol, used to indicate a security attribute of the current bus transmission. The signal has only 1 bit, and whether the transmission is non-secure or secure is distinguished by two states, “1” and “0”.

For example, if the processor core is executing a regular user software application that has no security requirement and accesses general data without involving sensitive system information, when the processor core initiates a bus request, the hardware state thereof indicates that the processor core is in the non-secure state, and the corresponding hardware circuit may set the Hnonsec signal to “1”. If the processor core executes a security software application that has a security requirement, for example, executes a system kernel code to perform critical operations such as security authentication or access to protected system resources, when the processor core initiates a bus request, the hardware state thereof indicates that the processor core is in the secure state, and the Hnonsec signal may be set to “0”. It is easy to understand that one transfer message may be written into the buffer processing unit via the bus through a single write operation, or may be split into a plurality of data blocks and written into the buffer processing unit via the bus through a plurality of write operations. Each time the transfer message is written into the buffer processing unit via the bus, the processor core initiates a bus request. for example, one transfer message may correspond to one or more bus requests. However, since a same transfer message is generated by processor cores in a same hardware state, values of Hnonsec signals for all bus requests corresponding to the same transfer message are the same.

The producer core writes the secure state signal along with the transfer message into the buffer processing unit corresponding to the producer core. A bold solid line with an arrow in FIG. 3 illustrates a transmission path of a secure state signal and a transfer message. For example, a transfer message and a secure state signal corresponding to the transfer message are transmitted together via the bus to the buffer processing unit, for processing by the buffer processing unit. For example, when writing a transfer message to the buffer processing unit corresponding thereto, the producer core initiates a bus request to the bus connected thereto. The bus request carries an Hnonsec signal. The Hnonsec signal is set by the producer core based on the hardware state thereof. Then, the Hnonsec signal and the corresponding transfer message are written together via the bus to the buffer processing unit corresponding to the producer core.

The security correction circuit is a sub-circuit in the buffer processing unit and is part of the buffer processing unit, which receives the secure state signal and the security flag bit in the corresponding transfer message as input, and corrects the security flag bit in the transfer message through logical calculation. It is easy to understand that the security flag bit in the transfer message, after being corrected by the security correction circuit, may change, for example, from “0” to “1”. For example, whether the transfer message is a secure transfer message or a non-secure transfer message may change, for example, from the secure transfer message to the non-secure transfer message.

The corrected security flag bit is applied to the transfer message, and the transfer message is transmitted only after the security flag bit thereof is corrected. More specifically, before the transfer message is buffered in the send buffer of the buffer processing unit, the security flag bit thereof has been corrected by the security correction circuit. The transfer message buffered in the send buffer is the transfer message with the corrected security flag bit. Then, the buffer processing unit transmits the transfer message with the corrected security flag bit. During the transmission of the transfer message from the send buffer in the buffer processing unit corresponding to the producer core to the receive buffer in the buffer processing unit corresponding to the consumer core, the security flag bit of the transfer message may not change.

According to the embodiments, whether the transfer message is a secure transfer message or a non-secure transfer message is determined by the software application generating the transfer message and is also determined by the hardware state of the producer core. The transfer message actually transmitted to the consumer core is the transfer message with the corrected security flag bit, which can more reliably determine whether the transfer message actually transmitted to the consumer core is a secure transfer message or a non-secure transfer message, and more reliably classify and process the transfer message, thereby effectively protecting transfer messages with different security levels. In addition, whether the producer core is in a secure state or a non-secure state may be indicated by using control signal bits in the bus, without requiring additional hardware components, which is easy to implement.

In some embodiments, the security correction circuit is configured to invert the security flag bit when the secure state signal indicates that the producer core is in the non-secure state and the security flag bit in the transfer message indicates that the transfer message is a secure transfer message, to cause the transfer message to be changed into a non-secure transfer message.

Generally, the producer core in the non-secure state, for example, the producer core on which the running software application does not have any security requirement, can only generate a non-secure transfer message. However, since the transfer message is generated by software running on the producer core, when a runtime error occurs in the software application, or when a software application having no security requirement maliciously tampers with the security flag bit of the transfer message, the producer core in the non-secure state may incorrectly generate a secure transfer message, which may affect system performance and communication security. In this case, the security correction circuit inverts the security flag bit of the transfer message, for example, inverts “0” to “1”, thereby changing the transfer message into a non-secure transfer message. Therefore, when the producer core is in the non-secure state, even if the software application running thereon generates and writes a secure transfer message into the buffer processing unit, the transfer message may be modified by the security correction circuit into a non-secure transfer message. Consequently, the transfer message actually transmitted to the consumer core is also a non-secure transfer message. In other words, when the producer core in the non-secure state writes a secure transfer message to the buffer processing unit corresponding thereto, the buffer processing unit modifies the written secure transfer message into a non-secure transfer message for subsequent transmission.

According to the embodiments, when the producer core is in the non-secure state, even if the software application incorrectly generates the transfer message as a secure transfer message, the buffer processing circuit can also correct the security level of the transfer message by inverting the security flag bit, so that the transfer message from the producer core in the non-secure state can only be transmitted as a non-secure transfer message, thereby preventing an influence on communication security due to software errors. In addition, the security correction circuit modifies the security level of the transfer message only by inverting the security flag bit, which may not modify the payload or other content of the transfer message, and may not reduce the reliability of transmission.

In some embodiments, the security correction circuit includes a first inverter, a second inverter, a third inverter, and an AND gate circuit, an input terminal of the first inverter serves as a first input terminal of the security correction circuit, an input terminal of the second inverter serves as a second input terminal of the security correction circuit, an output terminal of the first inverter and an output terminal of the second inverter are respectively connected to two input terminals of the AND gate circuit, an output terminal of the AND gate circuit is connected to an input terminal of the third inverter, and an output terminal of the third inverter serves as an output terminal of the security correction circuit. The secure state signal is input to the first input terminal of the security correction circuit, the security flag bit is input to the second input terminal of the security correction circuit, and a signal output from the output terminal of the security correction circuit serves as a corrected security flag bit.

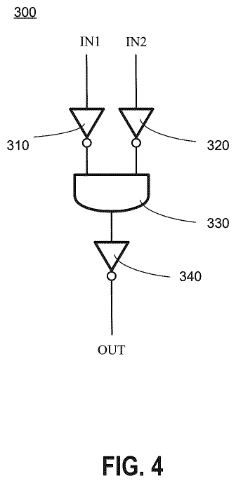

FIG. 4 is a schematic structural diagram of a security correction circuit according to embodiments of the present disclosure. As shown in FIG. 4, the security correction circuit 300 in the embodiments of the present disclosure has a first input terminal IN1 and a second input terminal IN2 as input terminals, and an output terminal OUT as an output terminal. The security correction circuit 300 includes a first inverter 310, a second inverter 320, a third inverter 340, and an AND gate circuit 330. An input terminal of the first inverter 310 serves as a first input terminal IN1 of the security correction circuit 300, an input terminal of the second inverter 320 serves as a second input terminal IN2 of the security correction circuit 300, and an output terminal of the first inverter 310 and an output terminal of the second inverter 320 are respectively connected to two input terminals of the AND gate circuit 330. For example, outputs of the first inverter 310 and the second inverter 320 serve as inputs to the AND gate circuit 330. An output terminal of the AND gate circuit 330 is connected to an input terminal of the third inverter 340. For example, an output of the AND gate circuit 330 serves as an input to the third inverter 340. An output terminal of the third inverter 340 serves as an output terminal OUT of the security correction circuit 300.

As described above, the secure state signal and the corresponding transfer message are written together into the buffer processing unit. In this case, the secure state signal is input to the first input terminal IN1 of the security correction circuit 300, and the security flag bit in the transfer message is input to the second input terminal IN2 of the security correction circuit 300. The security correction circuit 300 performs a logical operation on the input signal and outputs an operation result to the output terminal OUT. A signal outputted from the output terminal OUT of the security correction circuit 300 serves as the corrected security flag bit.

When the secure state signal is “1” indicating that the producer core is in the non-secure state, the secure state signal is “0” indicating that the producer core is in the secure state, the security flag bit is “1” indicating that the transfer message is a non-secure transfer message, and the security flag bit is “0” indicating that the transfer message is a secure transfer message, the security correction circuit 300 may have the following input/output situations.

In the first situation, if the input to the first input terminal IN1 is “0” and the input to the second input terminal IN2 is “0”, the output terminal OUT outputs “0”. This situation indicates that the producer core is in a secure state, and the transfer message generated by the software application running on the producer core is a secure transfer message. After being corrected by the security correction circuit 300, the transfer message actually transmitted to the consumer core remains a secure transfer message.

In the second situation, if the input to the first input terminal IN1 is “0” and the input to the second input terminal IN2 is “1”, the output terminal OUT outputs “1”. This situation indicates that the producer core is in a secure state, and the transfer message generated by the software application running on the producer core is a non-secure transfer message. After being corrected by the security correction circuit 300, the transfer message actually transmitted to the consumer core remains a non-secure transfer message. As can be seen from the situation, the producer core in the secure state is allowed to generate and transmit a non-secure transfer message. This is because, although the software application running on the producer core in the secure state has a security requirement, not all transfer messages generated by the software application having a security requirement are secure transfer messages. Non-secure transfer messages may alternatively be generated. In this case, there is no need to change the security of the transfer message, and the transfer message may continuously be transmitted as a non-secure transfer message.

In the third situation, if the input to the first input terminal IN1 is “1” and the input to the second input terminal IN2 is “1”, the output terminal OUT outputs “1”. This situation indicates that the producer core is in a non-secure state, and the transfer message generated by the software application running on the producer core is a non-secure transfer message. After being corrected by the security correction circuit 300, the transfer message actually transmitted to the consumer core remains a non-secure transfer message.

In the fourth situation, if the input to the first input terminal IN1 is “1” and the input to the second input terminal IN2 is “0”, the output terminal OUT outputs “1”. This situation indicates that the producer core is in a non-secure state, and the transfer message generated by the software application running on the producer core is a secure transfer message. After being corrected by the security correction circuit 300, the transfer message actually transmitted to the consumer core is changed into a non-secure transfer message.

As can be seen from the above, after the security flag bit is corrected, the security of the transfer message may or may not change. Specifically, if the transfer message generated by the software program running on the producer core is a non-secure transfer message, after the security flag bit is corrected by the security correction circuit 300, the transfer message remains a non-secure transfer message for subsequent transmission. If the transfer message generated by the software program running on the producer core is a secure transfer message, the security correction circuit 300 determines, according to the hardware state of the producer core, whether to change the transfer message to a non-secure transfer message for subsequent transmission.

According to the embodiments, whether the transfer message actually transmitted to the consumer core is a secure transfer message or a non-secure transfer message is determined by the hardware state of the producer core and the software program running on the producer core. The security correction circuit can appropriately correct the security flag bit of the transfer message under different situations, and more reliably determine whether the transfer message actually transmitted to the consumer core is a secure transfer message or a non-secure transfer message. The inter-core communication system can reliably classify and process transfer messages, thereby effectively protecting transfer messages with different security levels.

In some embodiments, the buffer processing unit further includes a configuration register, and a value of the configuration register can be set only by the processor core in the secure state. Moreover, the processor core in the secure state divides, by setting the value of the configuration register in the buffer processing unit corresponding to the processor core, the receive buffer into the secure buffer area and the non-secure buffer area, and sets the address ranges of the secure buffer area and the non-secure buffer area.

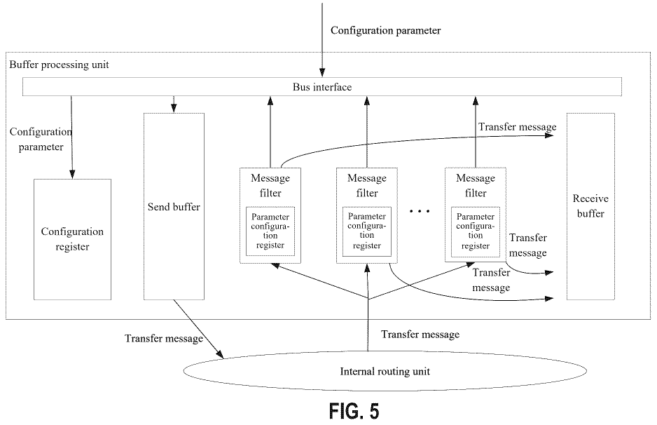

FIG. 5 is a schematic diagram of configuration of a buffer processing unit according to embodiments of the present disclosure. As shown in FIG. 5, the buffer processing unit includes a configuration register, and the configuration register is configured to define a predetermined address in the receive buffer in the buffer processing unit where the configuration register is located (hereinafter referred to as the receive buffer corresponding to the configuration register). For example, a predetermined address is written into the configuration register, serving as a value of the configuration register.

The value of the configuration register can be set only by the processor core in the secure state. This means that only the processor core in the secure state can access the security flag register and set and modify the value of the configuration register. Since the processor core in the secure state is running a software application having a security requirement, it may be understood that the value of the configuration register can be set only by the software application having a security requirement. More specifically, only when a processor core connected to the buffer processing unit where the configuration register is located is in a secure state, can the processor core in the secure state access the configuration register in the buffer processing unit corresponding to the processor core (i.e., connected via a bus). For example, the value of the configuration register can be set by a software application having a security requirement and running on the processor core in the secure state.

In the receive buffer, a memory region corresponding to an address range below the predetermined address (i.e., the address range in the receive buffer smaller than the predetermined address) may be a non-secure buffer area, and a memory region corresponding to an address range above the predetermined address (i.e., the address range in the receive buffer larger than the predetermined address) may be a secure buffer area. A specific setting is not limited thereto. In another example, the memory region corresponding to the address range below the predetermined address may be a secure buffer area, and the memory region corresponding to the address range above the predetermined address may be a non-secure buffer area. In other words, the predetermined address is a boundary address between the secure buffer area and the non-secure buffer area in the receive buffer.

Specifically, by setting the value of the configuration register in the buffer processing unit corresponding to the processor core, for example, by writing the predetermined address to the configuration register or modifying the value of the configuration register, the processor core in the secure state may divide the memory region in the receive buffer into two parts, for example, a secure buffer area and a non-secure buffer area. Correspondingly, since the predetermined address serves to divide the address range of the memory region in the receive buffer and an overall address range of the receive buffer is known, the address ranges of the secure buffer area and the non-secure buffer area can be determined.

In some examples, the configuration register has a default value, and the default value is a maximum address of the receive buffer corresponding to the configuration register. For example, by default, an overall address range of the receive buffer serves as the non-secure buffer area.

In some examples, the predetermined address is determined by a software application having a security requirement. The software application having a security requirement may determine a size of the secure buffer area and the non-secure buffer area according to a condition of the software application running in the inter-core communication system, more specifically, according to expected capacities of the secure transfer message and the non-secure transfer message, thereby determining the predetermined address to be written into the configuration register.

It should be understood that when in the non-secure state, the processor core cannot access the configuration register in the buffer processing unit corresponding thereto and cannot set and modify the value of the configuration register.

According to the embodiments, the configuration register can be configured only by the processor core in the secure state. This restriction ensures that critical address partitioning parameters may not be arbitrarily tampered with by a software application having no security requirement, thereby maintaining stability and reliability of security mechanisms of the system. Even if software having no security requirement attempts to alter the value of the configuration register, it may fail due to lack of configuration permissions.

In some embodiments, the buffer processing unit further includes: one or more message filters. The message filters correspond to different buffer address segments in the receive buffer. The one or more message filters are each configured to receive the transfer message routed from the buffer processing unit corresponding to the producer core, filter the received transfer message based on a respective filtering rule, and write a filtered transfer message to the corresponding buffer address segment.

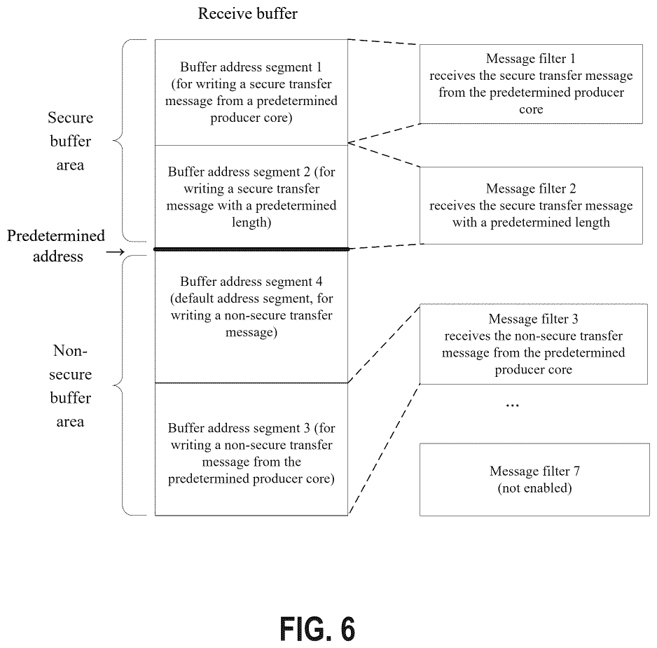

FIG. 6 is a schematic diagram of an example of a corresponding relationship between message filters and buffer address segments in a receive buffer according to embodiments of the present disclosure. Referring to FIG. 5 and FIG. 6 together, the message filters respectively correspond to different cache address segments in the receive buffer in the buffer processing unit where the message filters are located. Each message filter is configured with a predefined filtering rule. The message filter receives transfer messages from the internal routing unit and filters the received transfer messages. Filtering the transfer messages means selecting (retaining) the transfer messages meeting the predetermined filtering rules from the received messages. The message filter then writes the filtered transfer messages (for example, the transfer messages meeting a predetermined rule of the message filter) into the buffer address segment corresponding to the message filter. For example, the filtered transfer messages are buffered in the corresponding buffer address segment. The message filter may be implemented by a logic circuit. The processor core may set, by configuring the buffer processing unit corresponding thereto, which one(s) of the message filters in the buffer processing unit is/are to be specifically enabled. Each enabled message filter has a buffer address segment corresponding thereto, and address ranges of the buffer address segments corresponding to the enabled message filters do not overlap.

The filtering rule may be filtering one or more fields in the message header of the transfer message, for example, a producer-core identifier field, a length field, or a reserved field within a certain range. The filtering rule may alternatively filter the payload of the transfer message, for example, a payload meeting a predetermined condition. It is easy to understand that the filtering rule of one message filter can apply one or more filtering conditions simultaneously.

In some examples, as shown in FIG. 5, the receive buffer further includes a default address segment, and transfer messages not selected by any of the one or more message filters in the buffer processing unit may be written into the default address segment. For example, the buffer processing unit further includes a default filter, and the default filter corresponds to the default address segment. The transfer messages not selected by any of the one or more message filters in the buffer processing unit may enter the default filter, so as to be written into the default address segment. The default address segment is within the address range of the non-secure buffer area.

According to the embodiments, a specific transfer message may be distinguished from other transfer messages, facilitating management and use by the consumer core.

In some embodiments, each of the message filters includes a parameter configuration register, and the processor core configures, by setting a value of the parameter configuration register in the message filter in the buffer processing unit corresponding to the processor core, the filtering rule of the message filter and a range of the buffer address segment corresponding to the message filter.

Referring to FIG. 5 again, each message filter includes a parameter configuration register, and the message filter is configured by setting a value of the parameter configuration register. Specifically, each message filter may include a plurality of parameter configuration registers. By setting values of the parameter configuration registers, various functions of the message filter can be configured separately. More specifically, the setting of the values of the parameter configuration registers may change an actual operating circuit structure and logic of the message filter, thereby implementing different functions.

In practical applications, the filtering rule of each message filter and a range of each buffer address segment (e.g., start and end addresses of the buffer address segment) may be set according to an actual requirement. For example, if a certain type of transfer message is expected to have a large capacity, the buffer address segment to which the transfer messages are to be written may be set to a larger address segment range. In other words, the actual operating circuit structure and logic of the message filter may be configured according to an actual requirement by setting the value of the parameter configuration register.

It is easy to understand that n-1 enabled message filters correspond to n-1 buffer address segments in the receive buffer, and the receive buffer may include another default address segment used for writing transfer messages not selected by the n-1 enabled message filters. Therefore, in this case, the receive buffer includes n buffer address segments, and the buffer address segments are consecutive and do not overlap. Correspondingly, the transfer messages are classified into n types. One buffer address segment corresponds to one type of transfer message. For example, after being enabled, the message filter receives the value of the parameter configuration register and is then configured based on the value of the parameter configuration register. In the present disclosure, the message filter in which the parameter configuration register has been configured may be understood as an enabled message filter.

As shown in FIGS. 6, 7 message filters are integrated in one buffer processing unit, of which 3 message filters (a message filter 1, a message filter 2, and a message filter 3) are actually enabled. Filtering rules of the message filter 1, the message filter 2, and the message filter 3 are respectively selecting secure transfer messages from a predetermined producer core, selecting secure transfer messages that have a predetermined length, and selecting non-secure transfer messages from a predetermined producer core. The transfer messages selected by the three message filters may be respectively written into a buffer address segment 1, a buffer address segment 2, and a buffer address segment 3 in the receive buffer. Transfer messages not selected by any enabled message filter may be collectively written into a buffer address segment 4, which serves as the default address segment.

According to the embodiments, the message filters may be configured according to an actual requirement, making filtering of the transfer messages flexibly adaptable to different application scenarios.

In some embodiments, the parameter configuration register includes a security flag register, and a value of the security flag register is set only by the processor core in the secure state. The processor core in the secure state configures, by setting the value of the security flag register in the message filter, the message filter as a secure message filter or a non-secure message filter, the secure message filter is configured to filter the secure transfer message, and the non-secure message filter is configured to filter the non-secure transfer message. Moreover, the range of the buffer address segment corresponding to the secure message filter is located within the address range of the secure buffer area, and the range of the buffer address segment corresponding to the non-secure message filter is located within the address range of the non-secure buffer area.

As described above, each message filter may include a plurality of parameter configuration registers, and the security flag register is one of the plurality of parameter configuration registers. The value of the security flag register can be set only by the processor core in the secure state. This means that only the processor core in the secure state can access the security flag register and set and modify the value of the security flag register. Since the processor core in the secure state is running a software application having a security requirement, it may be understood that the value of the security flag register can be set only by the software application having a security requirement. More specifically, only when a processor core connected to the buffer processing unit where the security flag register is located is in a secure state, can the processor core in the secure state access the security flag register in the buffer processing unit corresponding to the processor core (i.e., connected via a bus). For example, the value of the security flag register can be set by a software application having a security requirement and running on the processor core in the secure state.

The security flag register is used to define whether the message filter where the security flag register is located is a secure message filter or a non-secure message filter. More specifically, the processor core in the secure state may configure, by setting the value of the security flag register, the message filter where the security flag register is located as a secure message filter or a non-secure message filter. The secure message filter is configured to filter security flag bits in the transfer messages, to select secure transfer messages. The non-secure message filter is configured to filter the security flag bits in the transfer messages, to select non-secure transfer messages. It is easy to understand that one buffer processing unit may include one or more secure message filters and one or more non-secure message filters.

As described above, each enabled message filter has a buffer address segment corresponding thereto. Accordingly, each secure message filter and each non-secure message filter have a buffer address segment corresponding thereto. The range of the buffer address segment corresponding to the secure message filter is located within the address range of the secure buffer area, and the range of the buffer address segment corresponding to the non-secure message filter is located within the address range of the non-secure buffer area. In this way, the secure transfer messages are routed to the secure buffer area, and the non-secure transfer messages are routed to the non-secure buffer area.

As described above, the processor core configures, by setting the value of the parameter configuration register in the message filter in the buffer processing unit corresponding thereto, the range of the buffer address segment corresponding to the message filter. In the embodiments, the processor core (specifically, the software application running on the processor core) can set only the corresponding buffer address segment within the address range of the secure buffer area by setting the value of the parameter configuration register of the secure message filter. If the processor core attempts to set the buffer address segment corresponding to the secure message filter within the address range of the non-secure buffer area, actual implementation cannot be performed, and an address-segment configuration error may be returned to the processor. Correspondingly, the processor core (specifically, the software application running on the processor core) can set only the corresponding buffer address segment within the address range of the non-secure buffer area by setting the value of the parameter configuration register of the non-secure message filter. If the processor core attempts to set the buffer address segment corresponding to the non-secure message filter within the address range of the secure buffer area, actual implementation cannot be performed, and an address-segment configuration error may be returned to the processor.

According to the embodiments, by configuring the secure message filter and the non-secure message filter, the secure transfer messages can only be routed to and buffered in the secure buffer area, and the non-secure transfer messages can only be routed to and buffered in the non-secure buffer area. Therefore, it is easy to distinguish the secure transfer messages from the non-secure transfer messages on the side of the consumer core.

In some embodiments, the value of the parameter configuration register in the message filter of the secure message filter can be set only by the processor core in the secure state.

As described above, the processor core in the secure state can set the value of the security flag register in the message filter in the buffer processing unit corresponding thereto, thereby configuring the message filter as a secure message filter or a non-secure message filter. When the message filter is configured as a secure message filter, all other parameter configuration registers in the message filter can be set only by the processor core in the secure state. For example, values of all other parameter configuration registers in the message filter (for example, all the parameter configuration registers in the message filter) can be set and modified only by the processor core in the secure state (more specifically, the software application running thereon having a security requirement). For example, when the message filter is configured as a secure message filter, other filtering rules and other settings of the secure message filter can be configured only by the processor core in the secure state.

On the other hand, when the message filter is configured as a non-secure message filter, all other parameter configuration registers in the message filter can be set by the processor core in the secure state or in the non-secure state. For example, values of all other parameter configuration registers in the message filter can be set and modified by the processor core in the secure state or in the non-secure state, and more specifically, by the software application having a security requirement or the software application having no security requirement running on the processor core. For example, when the message filter is configured as a non-secure message filter, other filtering rules and other settings of the non-secure message filter can be configured by the processor core in the secure state or in the non-secure state.

According to the embodiments, the configuration of the secure message filter can be performed only by the processor core in the secure state, which prevents tampering with the configuration of the secure message filter by the software application having no security requirement, thereby ensuring reliability of transmission and filtering of the secure transfer messages.

In another aspect of the present disclosure, a chip circuit is provided, including the inter-core communication system in the embodiments described above. For example, the chip circuit may be an SoC chip.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

1. An inter-core communication system, comprising:
a plurality of processor cores in a secure state or a non-secure state, and
a plurality of buffer processing circuits in one-to-one correspondence to the plurality of processor cores;
wherein
each of the processor cores is a producer core or a consumer core, the producer core being configured to generate a transfer message and write the transfer message into the buffer processing circuit corresponding to the producer core, the consumer core being configured to read the transfer message from the buffer processing circuit corresponding to the consumer core, the transfer message comprising a secure transfer message and a non-secure transfer message; and
each of the buffer processing circuits comprises a receive buffer, the receive buffer being divided into a secure buffer area and a non-secure buffer area, the secure transfer message being routed from the buffer processing circuit corresponding to the producer core to the secure buffer area of the buffer processing circuit corresponding to the consumer core, the non-secure transfer message being routed from the buffer processing circuit corresponding to the producer core to the non-secure buffer area of the buffer processing circuit corresponding to the consumer core, and the secure transfer message in the secure buffer area being read only by the consumer core in the secure state.

2. The inter-core communication system according to claim 1, wherein
the transfer message comprises a security flag bit indicating whether the transfer message is a secure transfer message or a non-secure transfer message;
the producer core is further configured to generate a secure state signal based on a hardware state of the producer core, and write the secure state signal along with the transfer message into the buffer processing circuit corresponding to the producer core, the secure state signal indicating whether the producer core is in a secure state or a non-secure state when writing the transfer message into the buffer processing circuit corresponding to the producer core; and
the buffer processing circuit comprises a security correction subcircuit, the security correction subcircuit being configured to correct, based on the secure state signal and the security flag bit in the transfer message, the security flag bit in the transfer message.

3. The inter-core communication system according to claim 2, wherein
the security correction subcircuit is configured to invert the security flag bit when the secure state signal indicates that the producer core is in the non-secure state and the security flag bit in the transfer message indicates that the transfer message is a secure transfer message, to cause the transfer message to be changed into a non-secure transfer message.

4. The inter-core communication system according to claim 2, wherein
the security correction subcircuit comprises a first inverter, a second inverter, a third inverter, and an AND gate subcircuit, an input terminal of the first inverter serving as a first input terminal of the security correction subcircuit, an input terminal of the second inverter serving as a second input terminal of the security correction subcircuit, an output terminal of the first inverter and an output terminal of the second inverter being respectively connected to two input terminals of the AND gate subcircuit, an output terminal of the AND gate subcircuit being connected to an input terminal of the third inverter, and an output terminal of the third inverter serving as an output terminal of the security correction subcircuit; and
the secure state signal is input to the first input terminal of the security correction subcircuit, the security flag bit is input to the second input terminal of the security correction subcircuit, and a signal output from the output terminal of the security correction subcircuit serves as a corrected security flag bit.

5. The inter-core communication system according to claim 1, wherein
the buffer processing circuit further comprises a configuration register, a value of the configuration register being set only by the processor core in the secure state; and
the processor core in the secure state divides, by setting the value of the configuration register in the buffer processing circuit corresponding to the processor core, the receive buffer into the secure buffer area and the non-secure buffer area, and sets an address range of the secure buffer area and an address range of the non-secure buffer area.

6. The inter-core communication system according to claim 5, wherein the buffer processing circuit further comprises: one or more message filters, the one or more message filters corresponding to different buffer address segments in the receive buffer; and
wherein each of the one or more message filters is configured to receive the transfer message routed from the buffer processing circuit corresponding to the producer core, filter the received transfer message based on a respective filtering rule, and write a filtered transfer message to the corresponding buffer address segment.

7. The inter-core communication system according to claim 6,
wherein each of the one or more message filters comprises a parameter configuration register, and
wherein the processor core configures, by setting a value of the parameter configuration register in the message filter in the buffer processing circuit corresponding to the processor core, the respective filtering rule of the message filter and a range of the buffer address segment corresponding to the message filter.

8. The inter-core communication system according to claim 7, wherein
the parameter configuration register comprises a security flag register, a value of the security flag register being set only by the processor core in the secure state; and
the processor core in the secure state configures, by setting the value of the security flag register in the message filter, the message filter as a secure message filter or a non-secure message filter, the secure message filter being configured to filter the secure transfer message, and the non-secure message filter being configured to filter the non-secure transfer message.

9. The inter-core communication system according to claim 8, wherein
the value of the parameter configuration register in the message filter of the secure message filter is set only by the processor core in the secure state.

10. A chip, comprising an inter-core communication system, wherein the inter-core communication system comprises:
a plurality of processor cores in a secure state or a non-secure state, and
a plurality of buffer processing circuits in one-to-one correspondence to the plurality of processor cores;
wherein
each of the processor cores is a producer core or a consumer core, the producer core being configured to generate a transfer message and write the transfer message into the buffer processing circuit corresponding to the producer core, the consumer core being configured to read the transfer message from the buffer processing circuit corresponding to the consumer core, the transfer message comprising a secure transfer message and a non-secure transfer message; and
each of the buffer processing circuits comprises a receive buffer, the receive buffer being divided into a secure buffer area and a non-secure buffer area, the secure transfer message being routed from the buffer processing circuit corresponding to the producer core to the secure buffer area of the buffer processing circuit corresponding to the consumer core, the non-secure transfer message being routed from the buffer processing circuit corresponding to the producer core to the non-secure buffer area of the buffer processing circuit corresponding to the consumer core, and the secure transfer message in the secure buffer area being read only by the consumer core in the secure state.

11. The chip according to claim 10, wherein
the transfer message comprises a security flag bit indicating whether the transfer message is a secure transfer message or a non-secure transfer message;
the producer core is further configured to generate a secure state signal based on a hardware state of the producer core, and write the secure state signal along with the transfer message into the buffer processing circuit corresponding to the producer core, the secure state signal indicating whether the producer core is in a secure state or a non-secure state when writing the transfer message into the buffer processing circuit corresponding to the producer core; and
the buffer processing circuit comprises a security correction subcircuit, the security correction subcircuit being configured to correct, based on the secure state signal and the security flag bit in the transfer message, the security flag bit in the transfer message.

12. The chip according to claim 11, wherein
the security correction subcircuit is configured to invert the security flag bit when the secure state signal indicates that the producer core is in the non-secure state and the security flag bit in the transfer message indicates that the transfer message is a secure transfer message, to cause the transfer message to be changed into a non-secure transfer message.

13. The chip according to claim 11, wherein
the security correction subcircuit comprises a first inverter, a second inverter, a third inverter, and an AND gate subcircuit, an input terminal of the first inverter serving as a first input terminal of the security correction subcircuit, an input terminal of the second inverter serving as a second input terminal of the security correction subcircuit, an output terminal of the first inverter and an output terminal of the second inverter being respectively connected to two input terminals of the AND gate subcircuit, an output terminal of the AND gate subcircuit being connected to an input terminal of the third inverter, and an output terminal of the third inverter serving as an output terminal of the security correction subcircuit; and
the secure state signal is input to the first input terminal of the security correction subcircuit, the security flag bit is input to the second input terminal of the security correction subcircuit, and a signal output from the output terminal of the security correction subcircuit serves as a corrected security flag bit.

14. The chip according to claim 10, wherein
the buffer processing circuit further comprises a configuration register, a value of the configuration register being set only by the processor core in the secure state; and
the processor core in the secure state divides, by setting the value of the configuration register in the buffer processing circuit corresponding to the processor core, the receive buffer into the secure buffer area and the non-secure buffer area, and sets an address range of the secure buffer area and an address range of the non-secure buffer area.

15. The chip according to claim 14, wherein the buffer processing circuit further comprises: one or more message filters, the one or more message filters corresponding to different buffer address segments in the receive buffer; and
wherein each of the one or more message filters is configured to receive the transfer message routed from the buffer processing circuit corresponding to the producer core, filter the received transfer message based on a respective filtering rule, and write a filtered transfer message to the corresponding buffer address segment.

16. The chip according to claim 15,
wherein each of the one or more message filters comprises a parameter configuration register, and
wherein the processor core configures, by setting a value of the parameter configuration register in the message filter in the buffer processing circuit corresponding to the processor core, the respective filtering rule of the message filter and a range of the buffer address segment corresponding to the message filter.

17. The chip according to claim 16, wherein
the parameter configuration register comprises a security flag register, a value of the security flag register being set only by the processor core in the secure state; and
the processor core in the secure state configures, by setting the value of the security flag register in the message filter, the message filter as a secure message filter or a non-secure message filter, the secure message filter being configured to filter the secure transfer message, and the non-secure message filter being configured to filter the non-secure transfer message.

18. The chip according to claim 17, wherein
the range of the buffer address segment corresponding to the secure message filter is located within the address range of the secure buffer area, and the range of the buffer address segment corresponding to the non-secure message filter is located within the address range of the non-secure buffer area.

19. The chip according to claim 17, wherein
the value of the parameter configuration register in the message filter of the secure message filter is set only by the processor core in the secure state.

20. The inter-core communication system according to claim 8, wherein
the range of the buffer address segment corresponding to the secure message filter is located within the address range of the secure buffer area, and the range of the buffer address segment corresponding to the non-secure message filter is located within the address range of the non-secure buffer area.
